(19) United States
(12) Patent Application Publication
(10) Pub. No.: US 2026/0236684 A1
(43) Pub. Date: Aug. 13, 2026

(54) MULTIMODAL RETRIEVAL AND ANSWER REFINEMENT

(71) Applicant: Adobe Inc., San Jose, CA (US)

(72) Inventors: Zhengyuan ZHU, Arlington, VA (US); Daniel LEE, San Jose, CA (US); Hong ZHANG, San Jose, CA (US); Sai Sree HARSHA, San Jose, CA (US); Loic FEUJIO, Upper Marlboro, MD (US); Akash Vivek MAHARAJAH, Palo Alto, CA (US); Yunyao LI, San Jose, CA (US); Shreya Anantha RAMAN, Seattle, WA (US)

(21) Appl. No.: 19/051,905

(22) Filed: Feb. 12, 2025

(51) Int. Cl. G06F 40/30; G06F 16/3329; G06F 16/36

(52) U.S. Cl. CPC G06F 40/30; G06F 16/3329; G06F 16/367

(57) ABSTRACT

In various examples, a multimodal question answering tool generates multimodal answers to queries. For example, a machine learning model generates a text answer to a query, the text answer snippets are compared to text snippets from a source document to determine attribution. Based on the attribution, multimodal data is obtained from the document and used to generate a prompt that, as a result of being provided to the machine learning model, causes the machine learning model to generate a multimodal answer.

### BACKGROUND

Various types of artificial intelligence (AI) models can perform question answering tasks. For example, large language models (LLMs) can be trained on a large corpus of data and extract or otherwise generate text-based answers to questions related to the large corpus of data. Furthermore, the answers generated by the AI models can be augmented with multimodal data such as images and video. However, these augmented answers often fall short of providing comprehensive and coherent multimodal answers, particularly in examples where the answer generated by the AI models attempts to explain concepts or provide step-by-step tutorials on how to accomplish specific goals and/or tasks. Oftentimes, multimodal data is crucial to helping users understanding complex domain-specific topics.

### SUMMARY

Embodiments described herein are directed to a question answering system that includes the retrieval of relevant multimodal data, which is used to refine answers generated in response to a prompt. Furthermore, in such embodiments, the retrieved multimodal data is included in the refined answers in order to provide coherent multimodal answers that integrate multimodal data and answer text. In various embodiments, aspects of the disclosure are directed towards text answer generation (e.g., in response to a user query and/or prompt), attribution-based retrieval of multimodal data from various sources, and multimodal answer refinement. In particular, a machine learning model such as a large language model (LLM) is trained on a corpus of data and integrated into a chat bot or other application that accepts or otherwise obtains user queries. For example, an LLM is trained (e.g., fine-tuned, pre-trained, or otherwise modified) based on a knowledge base, website, and/or other documentation (e.g., the corpus of data) including multimodal data. Continuing this example, in accordance with a user submitting a query to the LLM (e.g., “how do I create a schema for a table”), the LLM generates a text response answering the user's query.

In various embodiments, a second machine learning model (e.g., a sentence encoder) obtains text snippets from the response generated by the LLM and determines a source and/or attribution in order to obtain multimodal data associated with the response (e.g., the text snippets). For example, the second machine learning model determines matches between text snippets from the answer and text snippets from a source (e.g., the corpus of data). Continuing this example, the most similar and/or relevant text snippets from the source are used to determine a section and/or location within the source from which to retrieve multimodal data. In various embodiments, additional context associated with the multimodal data is used to determine multimodal data to retrieve and/or include in the response. For example, captions associated with images, transcripts associated with videos, and/or metadata associated with tables may be used as context associated with the multimodal data. The context, in various embodiments, is then provided as an input to the second machine learning model to determine multimodal data relevant to particular answer snippets from the response. In one example, the most relevant multimodal data determined by the second machine learning model based on a comparison of the context associated with the multimodal data and the text snippets from the response is retrieved from the source and used to refine the response generated by the LLM.

In various embodiments, the retrieved multimodal data is used to generate a prompt that is provided to the LLM to cause the LLM to refine the response. For example, a prompt is generated that includes the initial response generated by the LLM (e.g., the response used to retrieve the relevant multimodal data), the multimodal data, and the context associated with the multimodal data. In some embodiments, placeholders are used to represent the multimodal data in the prompt. The placeholder is used, for example, when the LLM does not accept multimodal data as an input. In an embodiment, the prompt is provided as an input to the LLM to generate a refined answer, and the refined answer is provided to the user in response to the user query. Returning to the example above, if a placeholder is included in the prompt, the refined answer is then modified to include the multimodal data before being provided to the user.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which a multimodal question answering system refines and generates answers based on multimodal data, in accordance with at least one embodiment.

FIGS. 3A and 3B depict query answers generated by a multimodal question answering system, in accordance with at least one embodiment.

FIG. 4 depicts a query answer generated by a multimodal question answering system, in accordance with at least one embodiment.

FIG. 5 depicts a prompt used to generate refined answers based on multimodal data, in accordance with at least one embodiment.

FIG. 6 depicts an example process flow for generating a multimodal data repository, in accordance with at least one embodiment.

FIG. 7 depicts an example process flow for generating and refining answers generated by a multimodal question answering system, in accordance with at least one embodiment.

FIG. 8 is a block diagram of a Large Language Model that uses particular inputs to make particular predictions, according to some embodiments.

FIG. 9 is a block diagram of an exemplary computing environment suitable for use in implementations of the present disclosure.

### DETAILED DESCRIPTION

In modern computing environments, users have access to various artificial intelligence (AI) tools to help process, digest, understand, query, or otherwise interact with documentation, websites, the Internet, or other collections of documents. For example, new tools including machine learning models, such as large language models (LLMs), are trained and used as AI assistants to enable users to interact with the LLMs and perform various operations. In particular, question answering (QA) tools are increasingly important to users, as the useful information for answering user queries is often difficult to locate due to the size and complexity of documentation such as enterprise websites and/or the Internet.

Furthermore, useful information, in many examples, is embedded in various other formats besides text such as images, tables, and videos. However, while conventional QA tools have made strides in generating text-based answers, such conventional QA tools struggle with integrating and synthesizing information from multiple modalities (e.g., images, videos, tables, etc.) into a coherent and contextually relevant response. In general, this shortcoming is particularly challenging in domain-specific use cases such as customer support, training, education, etc., where domain-specific answers combining text and visual elements are crucial for effective user understanding. For example, in enterprise websites, helpful information needed to answer user questions is often contained in public-facing documentation and embedded in various formats such as text, images, tables, and videos. However, current AI assistant and QA tools predominantly focus on generating text, which can be less effective than multimodal answers.

Furthermore, while some conventional systems attempt to incorporate multimodal data, such systems merely append multimodal data, such as images, to the end of the response. This limitation is especially problematic in complex scenarios (e.g., customer support, training, education, etc.) where users require comprehensive answers that integrate multimodal data retrieved from various sources. For example, providing a step-by-step guide to achieve a goal often involves incorporating user interface (UI) screenshots, instructional videos, and examples along with detailed textual instructions. As mentioned above, conventional systems providing such step-by-step guides, generally take the user query, extract a span of text from related documents or generate text using a decoder (e.g., Long Short-Term Memory [LSTM] decoder) to use as an answer and append multimodal data.

Other conventional systems prompt an LLM to generate both the text answer and associated multimodal content. While these conventional systems can retrieve relevant text and attach related images or videos, they are typically limited to answering simple questions, such as “What is coronavirus?”—where a basic text explanation is accompanied by an image. However, these conventional systems and the responses generated fail to synthesize the elements of the response into a coherent, unified response, thereby resulting in answers that are often incomplete or fragmented, as different data types are not fully integrated. Furthermore, these conventional systems often have limited contextualization and struggle to contextualize multimodal data within the framework of user queries, resulting in less relevant and harder-to-understand answers. Finally, conventional systems have difficulty scaling to handle diverse and complex user queries that require the integration of various data types.

In contrast, embodiments described herein include a multimodal question answering tool that generates coherent multimodal answers by integrating text, images, tables, and videos into a single, contextually relevant response. For example, relevant multimodal data is retrieved and/or obtained based on responses generated by a machine learning model. Such multimodal data and/or contextual information associated with the multimodal data is then used to refine responses by causing the machine learning model to generate a refined multimodal response that includes the multimodal data in the relevant portions of the response. The responses generated by the multimodal question answering tool, in various embodiments, offer various benefits over conventional systems such as increased productivity, reduced barriers to entry, higher product adoption rates, amplified creativity, and improved user experiences.

Accordingly, embodiments described herein generally relate to the multimodal question answering tool which: generates an initial text answer (e.g., instead of merely extracting text spans from documents), retrieves multimodal data relevant to this answer (e.g., by determining attribution for text snippets from the response), and refines the response to fully integrate the multimodal content (e.g., as opposed to merely appending the multimodal data to the response). In this regard, the systems and methods described are directed to a multimodal question answering tool that generates a cohesive and contextually appropriate response, including multimodal data, to user queries.

Embodiments of the technical solution can be explained by way of examples with reference to an AI assistant (e.g., a chat bot or other interface integrated into an application) that provides users with access to a multimodal question answering tool. In this way, the multimodal question answering tool is used to retrieve and integrate diverse data types (e.g., textual data and multimodal data) into cohesive and relevant answers. Continuing this example, the multimodal question answering tool ensures that users receive more informative responses in complex domain-specific settings such as enterprise and educational settings where multimodal information is often necessary.

In various embodiments, the multimodal question answering tool generates coherent multimodal answers by integrating diverse content types, including text, images, tables, and videos, into a single response. To do so, the multimodal question answering tool processes a collection of documents (e.g., textbooks, websites, etc.) and generates a collection of text document snippets, images, tables, and videos. In various embodiments, the collection of text document snippets, images, tables, and videos is stored in a repository. In addition, in some embodiments, the collection of text document snippets is used to train and/or fine-tune a machine learning model, such as an LLM (e.g., a pre-trained text embedding model), which is used to generate answers to user queries.

In various embodiments, a user query is obtained and provided as an input to the LLM to generate an answer to the user query. For example, the user query and relevant text snippets from the collection of text snippets are used to generate a prompt to the LLM to generate the answer. In various embodiments, the answer is then used to perform contextual retrieval (e.g., from the repository mentioned above) of multimodal content, which is used to generate a second multimodal answer that is coherently organized, relevant, and informative to a user's question, thereby addressing the limitations of other conventional systems. For example, text snippets extracted from the answer are matched to text document snippets. In one embodiment, extracted snippets from the answer are compared with text document snippets from the repository using the cosine similarities between their embeddings.

In various embodiments, once the relevant text document snippets (e.g., from the documents) are identified, multimodal data associated with the relevant text document snippets are retrieved. For example, multimodal data from the same section (e.g., chapter, webpage, heading, subheading, etc.) as the relevant text document snippets are retrieved. Furthermore, in some embodiments, context information associated with the multimodal data is then compared to the relevant text document snippets to determine if the multimodal data is relevant to the answer. In one example, an image caption associated with an image is compared to the relevant text document snippets (e.g., using cosine similarity) to ensure the multimodal data is relevant. In an embodiment, the multimodal data and context information associated with the multimodal data are used to generate a refined answer to the user query. For example, the user query, the initial answer (e.g., generated by the LLM), multimodal data, and/or context information are used to generate a second prompt to provide to the LLM to generate the refined answer. In an embodiment, placeholders are used in the prompt to represent the multimodal data. Finally, in various embodiments, the refined answer generated by the LLM based on the second prompt is provided in response to the user query. In one example, the multimodal question answering tool is adapted to various applications such as enterprise-level documentation tools, AI-driven customer service, educational tools, and other applications.

Advantageously, embodiments described herein enable the generation of comprehensive answers that integrate multimodal data retrieved from various sources. For example, providing a step-by-step guide to achieve a goal incorporating user interface (UI) screenshots, instructional videos, and examples along with detailed textual instructions. Furthermore, the multimodal data, in various embodiments, is integrated into cohesive and relevant answers and not merely appended to an answer or included as a secondary source. For example, contextual information is used not only to determine an appropriate location to include the multimodal data within an answer but to provide additional data used to refine an initial answer to generate a more cohesive and comprehensive answer that provides an improvement to the user experience.

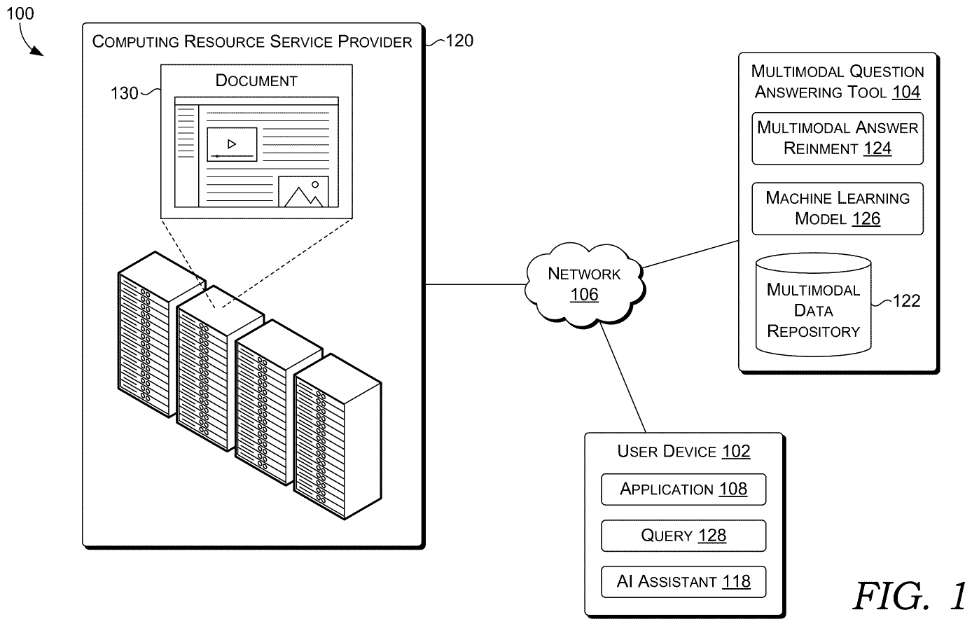

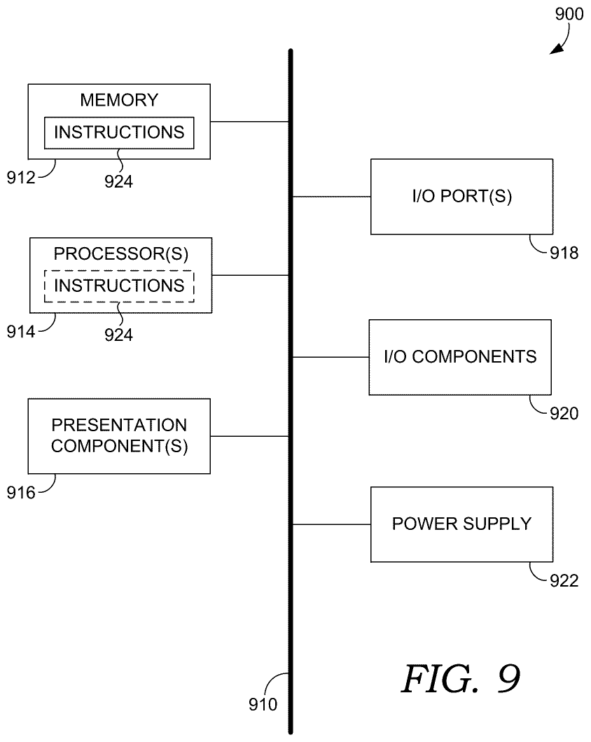

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 9.

It should be understood that operating environment 100 shown in FIG. 1 is an example of one suitable operating environment. Among other components not shown, operating environment 100 includes a user device 102, a multimodal question answering tool 104, and a network 106. Each of the components shown in FIG. 1 can be implemented via any type of computing device, such as one or more computing devices 900 described in connection with FIG. 9, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the multimodal question answering tool 104 may include multiple server computer systems cooperating in a distributed environment to perform the operations described in the present disclosure.

User device 102 can be any type of computing device capable of being operated by an entity (e.g., individual or organization) and provides a query 128 to the multimodal question answering tool 104 through an artificial intelligence (AI) assistant 118 of an application 108 and obtains an answer from the multimodal question answering tool 104 including multimodal data from a multimodal data repository 122. The user device 102, in various embodiments, has access to the multimodal question answering tool 104 through the AI assistant 118 in order to submit queries associated with a documentation 130. For example, the application 108 includes an enterprise-level application such as word processing, spreadsheet, database management, presentations, graphics, design, project management, accounting, development, education, or other applications that includes documentation or other text and multimodal data related to the application 108. In various embodiments, a computing resource service provider 120 provides documentation 130 associated with the application 108. In one example, the documentation 130 includes user manuals, help topics, tutorials, how-to guides, articles, technical documentation, training materials, community forums, release notes, technical support, or any other documents, videos, images, tables, or other data associated with the application 108. Although the example described in connection with FIG. 1 is related to documentation 130 related to the application 108, other types of documents associated with other domains can be used in connection with the embodiments described. In one example, the documentation 130 includes a textbook or other educational material. In another example, the documentation 130 includes a website.

In some implementations, user device 102 is the type of computing device described in connection with FIG. 9. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the multimodal question answering tool 104. For example, the application 108, supported by the computing resource service provider 120, includes the AI assistant 118, which provides a chat bot or other interface to allow the user to provide questions and/or queries. In some implementations, the application 108 comprises a web application, which can run in a web browser, and can be hosted at least partially on the server-side of the operating environment 100 (e.g., using computing resources of the computing resource service provider 120). In addition, or instead, the application 108 can comprise a dedicated application, such as an application being supported by the user device 102 and the multimodal question answering tool 104. In some cases, the application 108 is integrated into the operating system (e.g., as a service). It is therefore contemplated herein that “application” be interpreted broadly. Some example applications include ADOBE® Customer Journey Analytics, a cloud-based analytics service, and ADOBE® Experience League, which allows users to view, learn, educate, and access documentation associated with various ADOBE® products and services.

For cloud-based implementations, for example, the application 108 is utilized to interface with the functionality implemented by the multimodal question answering tool 104. In some embodiments, the components, or portions thereof, of the multimodal question answering tool 104 are implemented on the user device 102 or other systems or devices. Thus, it should be appreciated that the multimodal question answering tool 104, in some embodiments, is provided via multiple devices arranged in a distributed environment that collectively provide the functionality described herein. Additionally, other components not shown can also be included within the distributed environment.

As illustrated in FIG. 1, a user, through the user device 102, submits the query 128 to the AI assistant 118. As mentioned above, for example, the AI assistant 118 includes a chat bot or other user interface element that allows the user to submit queries. In some embodiments, the AI assistant 118 is operated by the computing resource service provider 120 and accessed through the application 108. For example, the application 108 includes a web browser that is used to access the application as service and/or web page providing access to the AI assistant 118 and/or multimodal question answering tool 104.

In various embodiments, the multimodal question answering tool 104 generates the multimodal data repository 122 by obtaining or otherwise accessing the documentation 130 maintained by the computing resource service provider 120. For example, the documentation 130 includes a web page or a website maintained or otherwise provided by the computing resource service provider 120. In various embodiments, a schema for multimodal data that can be applied to a website is used to construct a data ingestion pipeline. For example, the data ingestion pipeline is used to obtain the multimodal data (e.g., text snippets, images, tables, videos, etc.), determine a section and/or location associated with the multimodal data, generate or otherwise determine context information associated with the multimodal data, or other operations to store, maintain, or otherwise generate the multimodal data repository 122.

In various embodiments, relevant multimodal data from diverse sources (e.g., a plurality of documents 130) is obtained based on the query 128. Furthermore, in an embodiment, multimodal answer refinement 124 synthesizes multimodal data and answers generated by the machine learning model 126 to generate a coherent response that integrates and displays the multimodal data to the user (e.g., via the application 108).

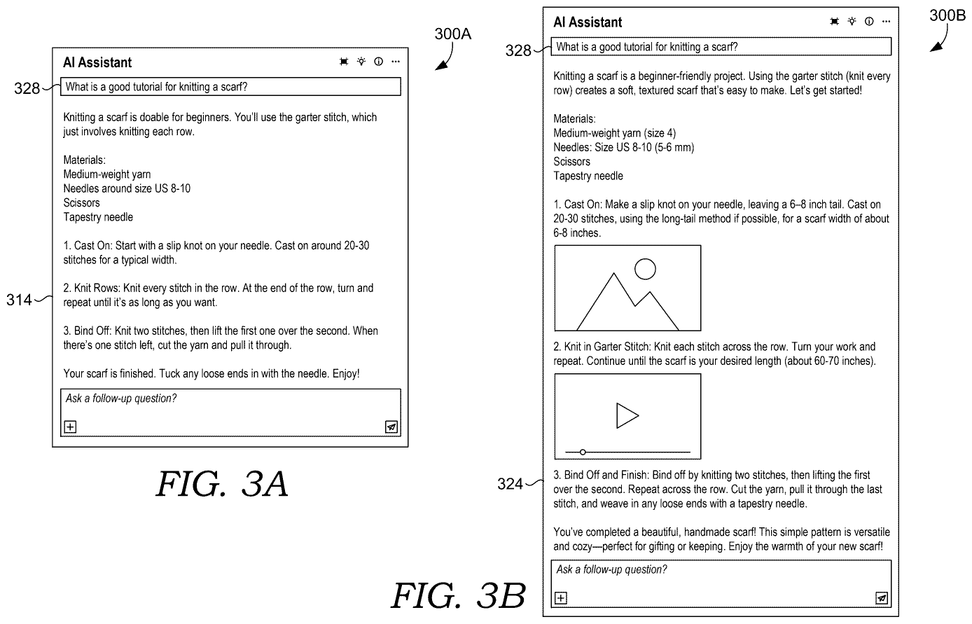

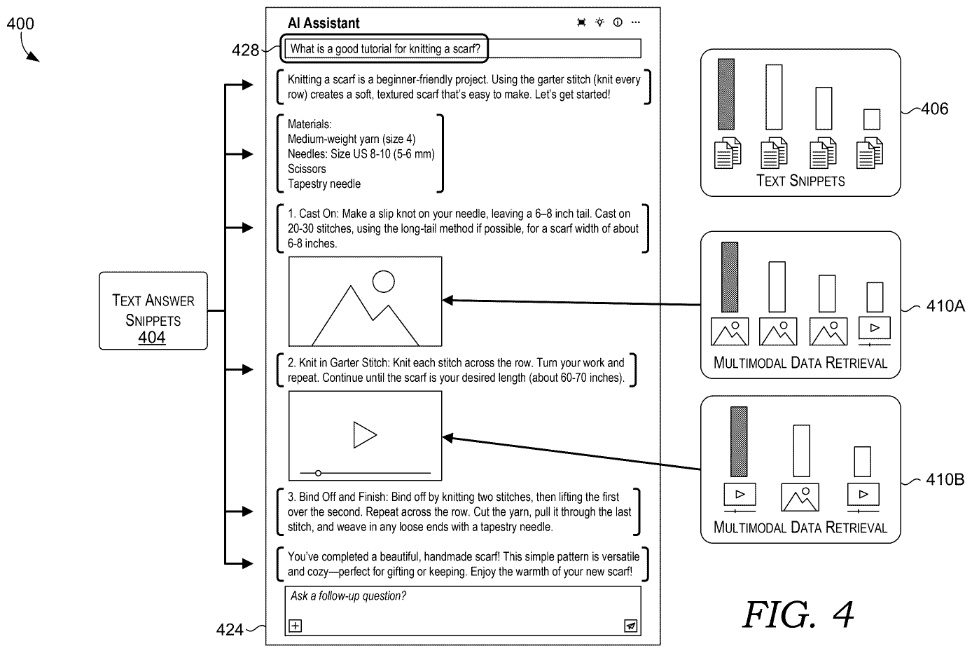

In various embodiments, the user device 102 (e.g., via the application 108) transmits the query 128 to the multimodal question answering tool 104. For example, the users submit the query 128 through a text box or similar user interface element (e.g., as illustrated in FIGS. 3A, 3B, and 4 described below) of the AI assistant 118, which causes the application 108 to transmit the query 128 over the network 106 to the multimodal question answering tool 104. In various embodiments, the multimodal question answering tool 104 generates a prompt based on the query 128 and provides the prompt as an input to the machine learning model 126, which generates a response based on the prompt. In one example, the machine learning model 126 is a pre-trained text embedding model (e.g., a language model) that is fine-tuned based on text snippets and context information included in the multimodal data repository 122. In various embodiments, the machine learning model 126 or other model is used to generate the context information. In one example, a first machine learning model is used to generate captions for images contained in the documentation 130; the captions are then stored in the multimodal data repository 122 as context information associated with the images. In another example, a second machine learning model is used to generate transcripts for videos contained in the documentation 130. The transcripts and/or summary of the transcripts, for example, are then stored in the multimodal data repository 122 as context information associated with the videos.

In various embodiments, the answer generated by the machine learning model 126 is used for multimodal answer refinement 124 by at least determining source attribution based on text snippets from the answer and text snippets included in the multimodal data repository 122. For example, a sentence encoder or other machine learning model determines the similarity between text snippets from the answer generated by the machine learning model 126 (e.g., the response to the prompt) and the text snippets extracted from the documentation 130 (e.g., text snippets included in the multimodal data repository 122) to determine a location associated with the documentation 130 that the machine learning model 126 used to generate the answer.

In various embodiments, the similarity between text snippets extracted from the answer and the text snippets extracted from the documentation 130, as determined by the sentence encoder, indicates a likelihood that the machine learning model 126 used the text snippets to generate the answer. In various embodiments, embeddings generated based on the text snippets of the answer generated by the machine learning model 126 are compared to embeddings generated based on the text snippets extracted from the documentation 130 using cosine similarity. For example, for a particular text snippet of the answer generated by the machine learning model 126, the text snippet from the documentation 130 with the highest cosine similarity score is determined and/or attributed as the source.

Once source attribution is determined, in various embodiments, a section or location associated with the text snippets from the documentation 130 is determined. For example, a uniform resource locator (URL) associated with the sections or location associated with the text snippets from the documentation 130 is used to determine multimodal data associated with the answer. In other examples, other information such as chapters, headings, sub-headings, timestamps, page number, word count, character count, row, column, hierarchy information, or other location information is determined based on the text snippets from the documentation 130 in order to obtain and/or determine multimodal data relevant to the answer generated by the machine learning model 126.

In various embodiments, the multimodal data is stored in the multimodal data repository 122. For example, the multimodal data is stored in an index and is associated with the text snippets extracted from the documentation 130. In other examples, the multimodal data is maintained in the documentation 130 and obtained once source attribution is determined. In various embodiments, a plurality of multimodal data is obtained for text snippets extracted from the answer generated by the machine learning model 126. For example, all of the multimodal data within a particular section and/or source determined during source attribution is extracted.

In various embodiments, the sentence encoder or other machine learning model used to determine source attribution is used to determine multimodal data to include in the refined answer. For example, context information associated with extracted multimodal data is used to generate embeddings, which are compared to the embeddings generated based on the text snippets of the answer generated by the machine learning model 126. In one example, embeddings are generated based on an image caption generated by an LLM taking the multimodal data as an input. In another example, the embeddings are generated based on the content of a table included in the multimodal data. In yet another example, the embeddings are generated based on a transcript of a video included in the multimodal data. In this example, the transcript may be generated by a machine learning model.

In various embodiments, once the embeddings are generated based on context information associated with the multimodal data, the multimodal data to be included in the refined answer is determined based on the cosine similarity between the embeddings based on context information associated with the multimodal data and the embeddings generated based on the text snippets of the answer generated by the machine learning model 126. For example, a particular multimodal data (e.g., video, image, or transcript) that has the highest cosine similarity with a particular text snippet from the answer is used to refine the answer and/or is included in the answer.

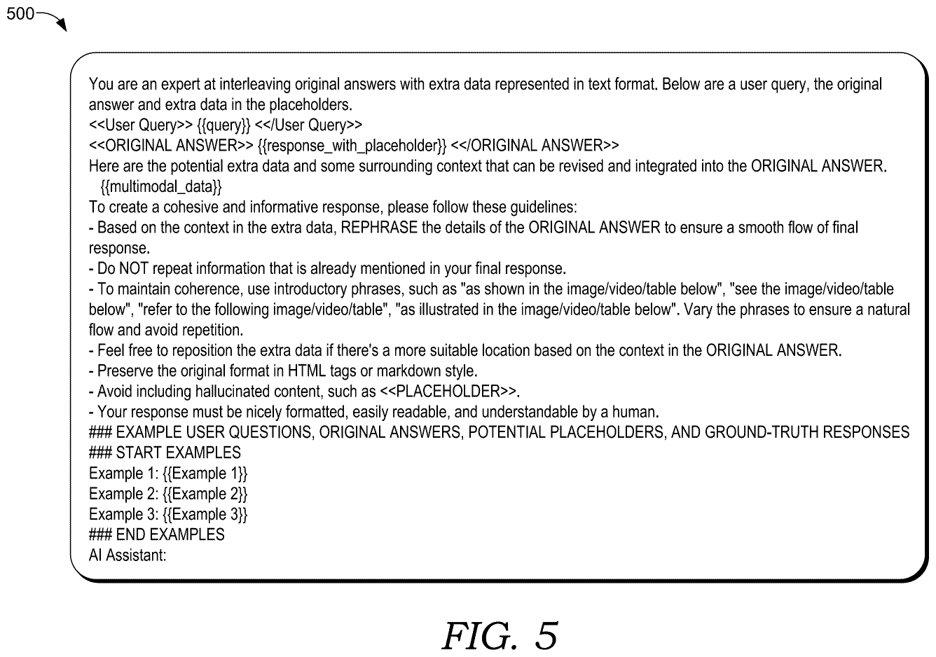

In various embodiments, multimodal answer refinement 124 includes generating a prompt to be input to the machine learning model 126 to cause the machine learning model 126 to generate the refined answer. For example, a template for a prompt, such as the prompt described below in connection with FIG. 5, is used to generate the input to the machine learning model 126. In one example, the prompt includes the query 128, the answer (e.g., the previous answer generated by the machine learning model 126), the context information associated with the multimodal data, and placeholders representing the multimodal data (e.g., locations to insert the relevant multimodal data once the refined answer is generated by the machine learning model 126). In other examples, other information such as examples, the multimodal data itself, domain-specific information, answer type information, or other information associated with the refined answer is also included in the prompt. In various embodiments, the information to be included in the prompt is concatenated and provided to the machine learning model 126 as a prompt. The refined answer, in various embodiments, is provided to the AI assistant 118 and displayed in the user interface of the application 108.

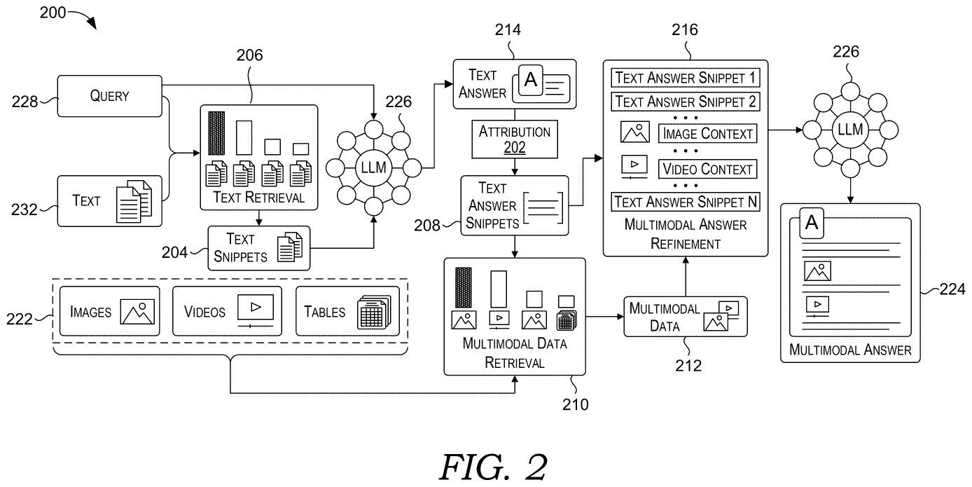

FIG. 2 depicts an environment 200 in which a multimodal question answering system refines and generates answers based on multimodal data 212, in accordance with at least one embodiment. In various embodiments, the multimodal question answering system depicted in the environment 200 includes a large language model (LLM) 226 that generates a multimodal answer 224 based on multimodal data 212 and a prompt 216. While some embodiments are described using the LLM 226 other type of models and/or language models (e.g., small language models) can be used in connection with the disclosure. Furthermore, in an embodiment, the LLM 226 includes a pre-trained model that is fine-tuned using a text 232. For example, text snippets 204 are extracted from the text 232 and used to update parameters and/or weights of the LLM 226. Although an LLM is used to describe embodiments depicted in FIG. 2, other language models (e.g., a small language model or a medium language model) or machine learning models can be used in the embodiments described.

In an embodiment, the text 232 includes various types of data such as documents, books, webpages, knowledge bases, or any other data that includes text and multimodal data 212. Furthermore, in an embodiment, the multimodal data 212 is extracted from the text 232 and stored in a multimodal data repository 222. Returning to that example above, a query 228 (e.g., a user question provided through a chat bot or other user interface of an application) is used as input to the LLM 226 and used to retrieve relevant text snippets 204 from the text 232. In various embodiments, a second machine learning model (e.g., a fine-tuned sentence-transformer model) performs text retrieval 206 to extract the text snippets relevant to the query 228 from the 232. In the example illustrated in FIG. 2, the most relevant text snippet determined during text retrieval is indicated by a shaded bar representing a similarity between a particular text snippet of the text 232 and the query 228.

In an embodiment, the text snippets 204 and query 228 are then used to prompt the LLM 226 to generate an initial text answer 214. In various embodiments, the text answer 214 is used to determine attribution 202 in order to retrieve relevant multimodal data 210 from the multimodal data repository 222. For example, attribution 202 is determined by at least obtaining relevant multimodal data 210, such as images, tables, or videos, from a multimodal ingestion pipeline to determine multimodal data 212 to include in the multimodal answer 224. In various embodiments, determining the attribution 202 includes two steps. First source attribution for text answer snippets 208 is determined based on similarity with the text snippets 204, and second section-level multimodal data retrieval is used to obtain relevant multimodal data 210 from corresponding sections of the text 232. For example, during the attribution 202 matches between the text answer snippet 208 and the corresponding text snippet 204 are determined. In an embodiment, the text answer 214 is divided into sentences (e.g., text answer snippets 208), and the sentence is compared with text snippets 204 using cosine similarity between their embeddings (e.g., generated by the second machine learning model such as a sentence encoder, LLM, or other machine learning model). In one example, the text snippet 204 with the highest cosine similarity score is identified as the source of the text answer snippet 208.

In various embodiments, once the source of the text answer snippet 208 is identified, multimodal data in the same section as the retrieved and/or extracted text snippet 204 is extracted or otherwise obtained from the text 232. For example, multimodal data from a webpage, chapter, section, or other location information associated with the text snippet 204 is retrieved (e.g., from the multimodal data repository 222) and used as relevant multimodal data 210. Once the relevant multimodal data 210 is obtained, in an embodiment, the second machine learning model determines the multimodal data 212 to include in the multimodal answer 224 (e.g., the most relevant multimodal data). In an embodiment, the relevant multimodal data 210 and text answer snippets 208 are provided to a machine learning model to determine which multimodal data 212 is the most relevant (e.g., illustrated by a shaded bar in FIG. 2) to include in the multimodal answer 224. In other embodiments, context information associated with the multimodal data 212 and additional text data is provided as an input for the machine learning model to determine relevance (e.g., in addition to or as an alternative to providing the relevant multimodal data 210 as an input to the machine learning model). For example, image captions, table content, video transcripts, metadata, or other context information is provided as an input to determine relevance.

In various embodiments, the prompt 216 is generated based on the text answer snippets 208 and multimodal data and, thereafter, provided to the LLM 226 to cause the LLM 226 to generate the multimodal answer 224. For example, the LLM 226 is provided with the query 228, text answer 214, multimodal data 212, and the context information associated with the multimodal data 212. In an embodiment, for the text answer snippets 208, placeholders (e.g., in the prompt 216) are added to the text answer 214 at the corresponding source locations from the text 232 (e.g., as determined during attribution 202). For example, the placeholder includes multimodal data 212 and context information, such that the LLM 226 accurately integrates relevant content without generating irrelevant details. In various embodiments, the prompt 216 is generated by concatenating the query 228, with a modified text answer 214 (e.g., the text answer 214 including the placeholders), the multimodal data 212, context information, and example answers (e.g., generated by a prompt engineer, from previously generated answers, etc.).

FIGS. 3A and 3B depict user interfaces 300A and 300B displaying query answers generated by a multimodal question answering system, in accordance with at least one embodiment. In various embodiments, the user interfaces 300A and 300B are displayed by an application executed by a computing device such as the application 108 described above in connection with FIG. 1. In an embodiment, the user interfaces 300A and 300B depict an AI assistant and/or chat bot that allows users to input queries to a text box 328.

In various embodiments, the application displaying the user interfaces 300A and 300B provides the query input into the text box 328 to the question answering system, as described in various embodiments. Turning to FIG. 3A, the example illustrated includes a text answer 314 generated based on the query input into the text box 328. The text answer 314, in an embodiment, is generated by an LLM based on the query and text, such as the text answer 214 described above in connection with FIG. 2.

FIG. 3B illustrates a multimodal answer 324 generated by the question answering system. For example, the multimodal answer 324 includes multimodal data such as multimodal data 212, as described above in connection with FIG. 2 that is relevant to the text answer 314. Furthermore, in various embodiments, the multimodal data is used to refine the text answer 314 and generate the multimodal answer 324. In one example, a prompt is generated using the query, the text answer 314, the multimodal data, context information, and other information suitable for refining the text answer 314.

FIG. 4 depicts a user interface 400 displaying a multimodal answer 424 generated by a multimodal question answering system, in accordance with at least one embodiment. In various embodiments, the multimodal answer 424 is generated using the multimodal question answering system described above in connection with FIG. 2. For example, the multimodal answer 424 includes text answer snippets 404 generated by a machine learning model such as the LLM 226. Furthermore, in an embodiment, text answer snippets 404 are compared to text snippets 406 from a source document such as a website, text, knowledgebase, or other documents including multimodal data. For example, cosine similarity is used to determine attribution for a particular text answer snippet. Continuing with this example, determining a section or location of the most similar text snippet indicates where to retrieve potentially relevant multimodal data, such as multimodal data 410A and 410B.

In various embodiments, for the text answer snippets 404, relevant multimodal data is retrieved and compared to the corresponding text answer snippet to determine relevance. In one example, if a cosine similarity is determined based on the multimodal data and the text answer snippet is not above a threshold, the multimodal data is not included in the multimodal answer 424. In another example, no multimodal data is retrieved because the section corresponding to the most relevant text snippet 406 to the text answer snippet 404 does not include multimodal data. However, in other examples where multimodal data is retrieved or otherwise obtained, the multimodal data 410A and/or 410B is compared to the text answer snippets 404, and the most relevant multimodal data is included in the multimodal answer 424. In various embodiments, context information associated with the multimodal data and a corresponding text answer snippet 404 is provided to a machine learning model to determine relevance (e.g., cosine similarity).

FIG. 5 depicts a prompt 500 used to generate refined answers based on multimodal data, in accordance with at least one embodiment. In various embodiments, the prompt 500 is generated based on the text answer snippets and multimodal data and is provided to an LLM. In response, the LLM, for example, generates a multimodal answer, such as the multimodal answer 224 described above in connection with FIG. 2. For example, the prompt 500 includes a query provided by a user, text answer generated by the LLM based on the query, multimodal data that is relevant to text answer snippets from the text answer, and the context information associated with the multimodal data. In an embodiment, placeholders, illustrated as “<<PLACEHOLDER>>” or “{{multimodal_data}}” in FIG. 5, are added to allow the question answering system to insert additional data (e.g., the multimodal data) after the LLM generates the refined answer. For example, the placeholder includes multimodal data and context information, such that the LLM accurately integrates relevant content without generating irrelevant details. In various embodiments, the prompt is generated by concatenating the query, the text answer, the multimodal data, context information, and example answers.

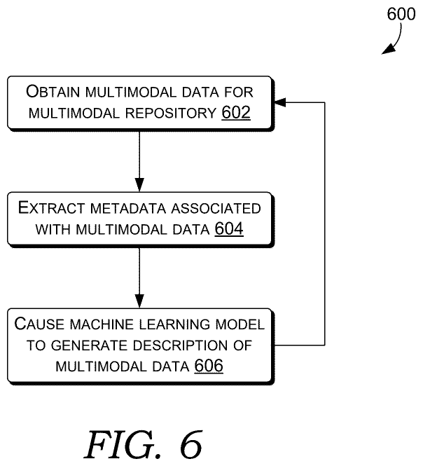

FIG. 6 is a flow diagram showing a method 600 for generating a multimodal data repository in accordance with at least one embodiment. The methods 600 and 700 can be performed, for instance, by the multimodal question answering tool 104 of FIG. 1. Each block of the method 600 and 700 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, the system implementing the method 600 obtains multimodal data for a multimodal data repository. As described above in connection with FIG. 1, in various embodiments, a document, text, webpage, or other data includes text and multimodal data. The multimodal data, for example, is extracted through a multimodal ingestion pipeline that processes the multimodal data for the multimodal question answering tool.

At block 604, the system implementing the method 600 extracts metadata associated with the multimodal data. For example, a metadata associated with the multimodal data is used as context information associated with the multimodal data in order to determine or otherwise obtain additional information associated with the multimodal data. Examples of metadata include a transcript of a video, tags associated with images, contents of a table, or other data.

At block 606, the system implementing the method 600 causes a machine learning model to generate a description of the multimodal data. For example, the metadata and the multimodal data are provided as an input to the machine learning model, which generates context information associated with the multimodal data. For example, the multimodal data includes an image, and the machine learning model generates a caption or other description based on the image and/or metadata associated with the image (e.g., a title, author, date, location, etc.). In another example, the multimodal data includes a video, and the machine learning model generates a transcript or other description based on the video, audio track, and/or metadata associated with the video (e.g., a title, director, location, actors, etc.).

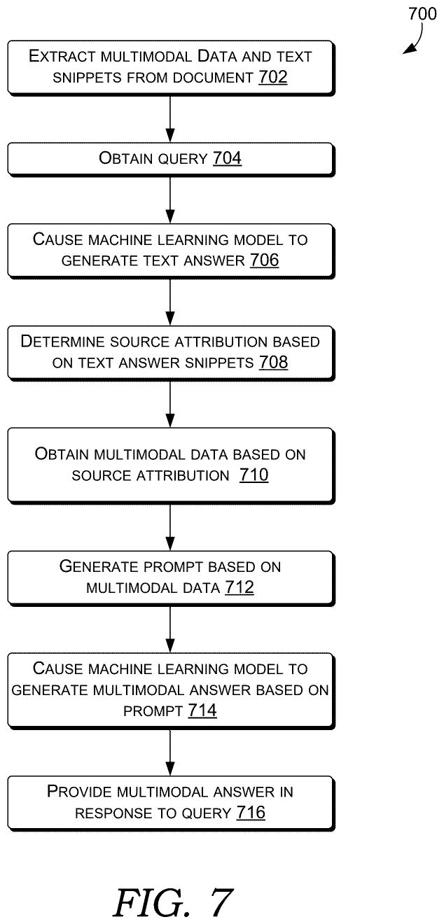

FIG. 7 depicts an example process flow for generating and refining answers generated by a multimodal question answering system in accordance with at least one embodiment. As shown at block 702, the system implementing the method 700 extracts multimodal data and text snippets from documents. For example, sentences (e.g., text snippets), images, videos, tables, and other data are extracted from a webpage or other data source. As described above, the text snippets and multimodal data are used to fine-tune a pre-trained LLM.

At block 704, the system implementing the method 700 obtains a query. For example, a user provides a query through an AI assistant and/or chat bot of an application with a question related to the document or other data ingested by the question answering tool. At block 706, the system implementing the method 700 causes the machine learning model to generate a text answer based on the query. For example, the query and the text snippets extracted from the document are provided as an input to the machine learning model, and the machine learning model outputs the text answer to the query.

At block 708, the system implementing the method 700 determines source attribution based on text answer snippets. For example, sentences of the text answer are compared to text snippets from the document using a sentence encoder model to determine the similarity between the sentence of the text answer and text snippets from the document. As described above, in various embodiments, the most similar text snippets indicate locations within the document to attribute the text answer to and indicate where in the document to obtain multimodal data. At block 710, the system implementing the method 700 obtains multimodal data based on the source attribution. For example, the system implementing the method 700 obtains the multimodal data from a webpage corresponding to the text snippet most similar to the text answer snippet.

At block 712, the system implementing the method 700 generates a prompt based on the multimodal data. For example, the prompt is generated by combing the query, the text answer, the multimodal data, context information associated with the multimodal data, instructions, and the example answer. At block 714, the system implementing the method 700 causes the machine learning model to generate the multimodal answer based on the prompt. In one example, the LLM takes the prompt as an input and outputs the multimodal answer. In some embodiments, the prompt includes placeholders and data, such as the multimodal data, that are inserted into the multimodal answer after the LLM generates the multimodal answer. At block 716, the system implementing the method 700 provides the multimodal answer in response to the query. For example, the multimodal answer is displayed in a user interface of an application.

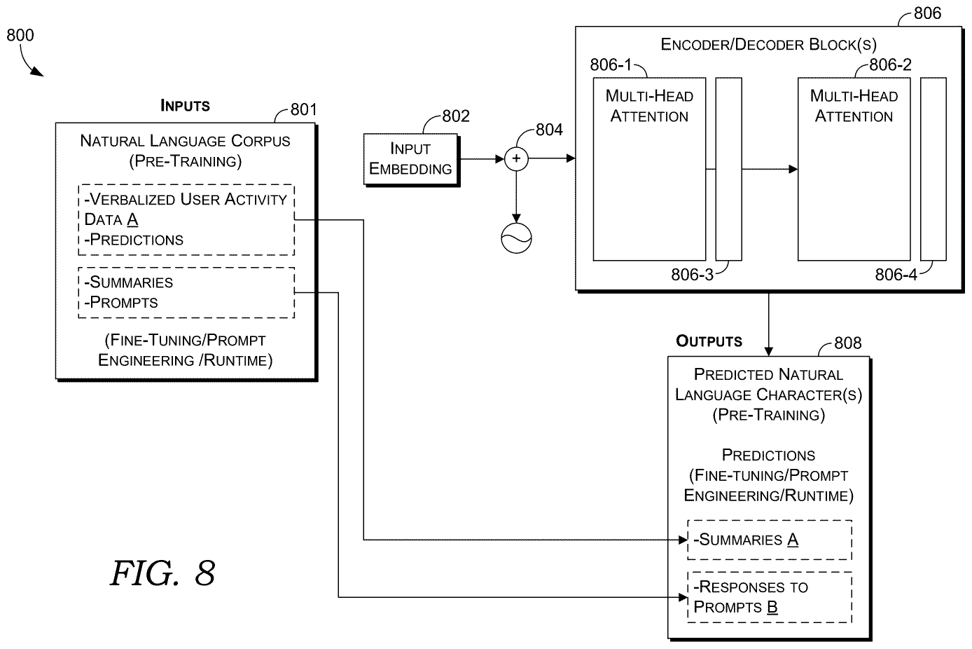

FIG. 8 is a block diagram of a Language Model 800 (e.g., a bidirectional encoder representations from transformers [BERT] model or a generative pre-trained transformer 4 [GPT-4] model) that uses particular inputs to make particular predictions (e.g., answers to questions), according to some embodiments. In some embodiments, this model 800 represents or includes the functionality as described with respect to the multimodal question answering tool 104 and/or the machine learning model 126 of FIG. 1. In various embodiments, the language model 800 includes one or more encoders and/or decoder blocks 806 (or any transformer or portion thereof).

First, a natural language corpus (e.g., various WIKIPEDIA English words or BooksCorpus) of the inputs 801 are converted into tokens and then feature vectors and embedded into an input embedding 802 to derive meaning of individual natural language words (for example, English semantics) during pre-training. In some embodiments, to understand English language, corpus documents, such as text books, periodicals, blogs, social media feeds, and the like are ingested by the language model 800.

In some embodiments, each word or character in the input(s) 801 is mapped into the input embedding 802 in parallel or at the same time, unlike existing long short-term memory (LSTM) models, for example. The input embedding 802 maps a word to a feature vector representing the word. But the same word (for example, “apple”) in different sentences may have different meanings (for example, phone versus fruit). This is why a positional encoder 804 can be implemented. A positional encoder 804 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector as follows:

$${PE}_{( pos , 2 i )} = sin ( pos / 1000 {0}^{2 i / {d}_{model}} )$$

$${PE}_{( pos , 2 i + 1 )} = cos ( pos / 1000 {0}^{2 i / {d}_{model}} ) .$$

After passing the input(s) 801 through the input embedding 802 and applying the positional encoder 804, the output is a word embedding feature vector, which encodes positional information or context based on the positional encoder 804. These word embedding feature vectors are then passed to the encoder and/or decoder block(s) 806, where they go through a multi-head attention layer 806-1 and a feedforward layer 806-2. The multi-head attention layer 806-1 is generally responsible for focusing or processing certain parts of the feature vectors representing specific portions of the input(s) 801 by generating attention vectors. For example, in question answering systems, the multi-head attention layer 806-1 determines how relevant the i^{th} word (or particular word in a sentence) is for answering the question or relevant to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention layer has abstract vectors Q, K, and V that extract different components of a particular word. These are used to compute the attention vectors for every word, using the following formula:

$$Z = softmax ( \frac{Q \cdot {K}^{T}}{\sqrt{Dimension of vector Q , K or V}} ) \cdot V .$$

For multi-headed attention, there are multiple weight matrices W^{q}, W^{k}, and W^{v} so that there are multiple attention vectors Z for every word. However, a neural network may only expect one attention vector per word. Accordingly, another weighted matrix, W^{z}, is used to make sure the output is still an attention vector per word. In some embodiments, after the layers 806-1 and 806-2, there is some form of normalization (for example, batch normalization and/or layer normalization) performed to smoothen out the loss surface, making it easier to optimize while using larger learning rates.

Layers 806-3 and 806-4 represent residual connection and/or normalization layers where normalization recenters and rescales or normalizes the data across the feature dimensions. The feedforward layer 806-2 is a feedforward neural network that is applied to every one of the attention vectors outputted by the multi-head attention layer 806-1. The feedforward layer 806-2 transforms the attention vectors into a form that can be processed by the next encoder block or that can make a prediction at 808. For example, given that a document includes first natural language sequence “the due date is . . . ,” the encoder/decoder block(s) 806 predicts that the next natural language sequence will be a specific date or particular group of words based on past documents that include language identical or similar to the first natural language sequence.

In some embodiments, the encoder/decoder block(s) 806 includes pre-training to learn language (pre-training) and make corresponding predictions. In some embodiments, there is no fine-tuning because some embodiments perform prompt engineering, prompt-tuning, or zero-shot learning. “Prompt engineering” refers to a process of designing or using structured input to the model (referred to as a prompt or prompts) to cause a desired response to be generated by the model. In some embodiments, prompt engineering includes creating the best or optimal prompt, or series of prompts, for the desired user task or output. Accordingly, given a first prompt (which may include target content), if the model produces a first output with a high likelihood of not being the correct response, particular embodiments learn, such that a second output (indicative of high likelihood of being the correct response) is always produced when such a first prompt is provided as input. In this way, at model deployment time, no output is ever produced with a low likelihood of being the correct response if the first prompt (or variation thereof) is provided, thereby increasing the accuracy of the model's generative outputs.

Pre-training is performed to understand language, and fine-tuning is performed to learn a specific task, such as learning an answer to a set of questions (in question answering systems). In some embodiments, the encoder/decoder block(s) 806 learns what language and context for a word is in pre-training by training on two unsupervised tasks (masked language model [MLM] and next sentence prediction [NSP]) simultaneously or at the same time. In terms of the inputs and outputs, at pre-training, the natural language corpus of the inputs 801 may be various historical documents, such as text books, journals, and periodicals, in order to output the predicted natural language characters in 808 (and not make the predictions at runtime or prompt engineering at this point). The encoder/decoder block(s) 806 takes in a sentence, paragraph, or sequence (for example, included in the input[s] 801), with random words being replaced with masks. The goal is to output the value or meaning of the masked tokens. For example, if a line reads, “please [MASK] this document promptly,” the prediction for the “mask” value is “send.” This helps the encoder/decoder block(s) 806 understand the bidirectional context in a sentence, paragraph, or line at a document. In the case of NSP, the encoder/decoder block(s) 806 takes, as input, two or more elements, such as sentences, lines, or paragraphs, and determines, for example, if a second sentence in a document actually follows (for example, is directly below) a first sentence in the document. This helps the encoder/decoder block(s) 806 understand the context across all the elements of a document, not just within a single element. Using both of these together, the encoder/decoder block(s) 806 derives a good understanding of natural language.

In some embodiments, during pre-training, the input to the encoder/decoder block(s) 806 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 802). At the output side is the binary output for the next sentence prediction. For example, this component may output one, for example, if masked sentence two follows (for example, is directly beneath) masked sentence one. The output is word feature vectors that correspond to the outputs for the machine learning model functionality. Thus, the number of word feature vectors that are input is the same number of word feature vectors that are output.

In some embodiments, the initial embedding (for example, the input embedding 802) is constructed from three vectors: the token embeddings, the segment or context question embeddings, and the position embeddings. In some embodiments, the following functionality occurs in the pre-training phase. The token embeddings are the pre-trained embeddings. The segment embeddings are the sentence numbers (that include the input[s] 801) that is encoded into a vector (for example, first sentence, second sentence, etc., assuming a top-down and right-to-left approach). The position embeddings are vectors that represent the position of a particular word in such sentence that can be produced by positional encoder 804. When these three embeddings are added or concatenated together, an embedding vector is generated that is used as input into the encoder/decoder block(s) 806. The segment and position embeddings are used for temporal ordering since all of the vectors are fed into the encoder/decoder block(s) 806 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected, layered output with the same number of neurons equal to the same number of tokens in the vocabulary.

In some embodiments, once pre-training is performed, the encoder/decoder block(s) 806 performs prompt engineering or fine-tuning on a variety of QA data sets by converting different QA formats into a unified sequence-to-sequence format. For example, some embodiments perform the QA task by adding a new question answering head or encoder/decoder block, just the way a masked language model head is added (in pre-training) for performing an MLM task, except that the task is a part of prompt engineering or fine-tuning. This includes the encoder/decoder block(s) 806 processing the inputs 801 (i.e., the verbalized user activity data, the predictions, summaries, and/or prompts) in order to make the predictions and confidence scores, as indicated in output 808. Prompt engineering, in some embodiments, is the process of crafting and optimizing text prompts for language models to achieve desired outputs. In other words, prompt engineering is the process of mapping prompts (e.g., a question) to the output (e.g., an answer) that it belongs to for training. For example, if a user asks a model to generate a poem about a person fishing on a lake, the expectation is that it will generate a different poem each time. Users may then label the output or answers from best to worst. Such labels are an input to the model to make sure the model is giving more human-like or best answers, while trying to minimize the worst answers (e.g., via reinforcement learning). In some embodiments, a “prompt” as described herein includes one or more of: a request (e.g., a question or instruction [e.g., write a poem]), target content, a command or instruction, and/or other examples (e.g., one-shot or two-shot examples).

In an illustrative example, in some embodiments, the predictions of the output 808 may be generative text, chart, graphs, or other visualizations, such as those described above with FIGS. 3A and 3B. Alternative to prompt engineering or fine-tuning, in some embodiments the inputs 801 and outputs 808 represent “runtime” inputs and outputs. Runtime represents a time after which the model 800 has been trained (e.g., via pre-training and/or fine-tuning and/or prompt engineering), tested, and deployed.

An artificial intelligence (AI) system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases, entirely different from data they are trained on.

Artificial intelligence systems can include transformer models that are capable of running complex neural language processing tasks. Transformer models—also known as Large Language Models (LLMs)—have applications in a wide range of industries. An LLM is a trained deep learning model that can recognize, summarize, translate, predict, and generate content using very large datasets. LLMs and other types of generative AI models are associated with a training phase—where a model is taught to learn patterns, relationships, and knowledge from training datasets—and an inference phase, which includes making predictions, classifications, or generating outputs for real-world tasks or queries.

Unlike convolution neural networks (CNNs), which are typically used for image tasks and mostly rely on convolution operations, transformer models are based on simple general matrix multiplication (GEMM) tasks, which can be further broken down to perform a dot product operation on two vectors. While CNN architectures are typically computationally heavy with a relatively small number of parameters, the architecture of transformer models results in the opposite: a very large number of parameters, with a fairly small number of operations. The LLM architecture can create challenges in that performance bottlenecks reside in the memory throughput and capacity rather than the compute engine.

Transformer models operate with memory accesses to retrieve a matrix of weights out of memory, together with a vector (either the input vector or partial result from a previous stage of the model), and multiplying the two. This is true for the model's attention sublayers, the FFN (feedforward network), sublayers, and for the final embedding layer. As vector-matrix multiplication is actually comprised of numerous vector-vector multiplications (dot product), it is fair to say that most memory accesses are used to read two vectors in order to perform a dot product on them. As such, reading out the full vectors is inefficient.

As such, transformer models (also referred to herein as “generative AI models”) require computational resources including processors and memory for the training phase and inference phase. The generative AI models operate with different types of processors (e.g., central processing units [CPUs] or graphics processing units [GPUs]) in architectures that include multi-core CPUs or parallel processors including GPUs and tensor processing units (TPUs). Memory can be used to store model parameters and intermediate data for the training phase and the inference phase. Memory requirements may depend on the size and the architecture of the generative AI models. By way of illustration, an LLM can support an inferencing phase that includes using a trained model to make predictions, draw conclusions, or generate output based on input data or patterns learned during the model's training phase. During the inference phase, an LLM can use DRAM (Dynamic Random-Access Memory) to store various components and data for making inferences. LLMs can store their pre-trained model parameters (e.g., weights and biases of the neural network layers) in DRAM, and when a new input is provided for inference, the model accesses these parameters from DRAM to make predictions.

The inference phase can be divided into two stages: a prompt stage and an auto-regressive stage. The prompt stage can include receiving and processing input as a batch of new tokens as part of the same inference. The prompt stage may operate based on a Key-Value (KV) cache technique, where a KV cache is created for tokens in a batch. During the prompt stage, the input is being digested. The auto-regressive state can include using the model to generate the tokens one by one, based on previous tokens, relying on reading the KV cache of previously processed tokens, and adding the data of only new tokens to the KV cache. This auto-regressive stage includes the model generating a response to the input from the prompt stage.

Having described embodiments of the present disclosure, FIG. 9 provides an example of a computing device in which embodiments of the present disclosure may be employed. Computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 9 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 9 and make reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built-in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B, and C).”

What is claimed is:

1. A method comprising:
obtaining a user query;
causing a first machine learning model to generate a first response to the user query;
extracting a first set of text snippets from the first response;
causing a second machine learning model to determine source attribution by matching a first text snippet of the first set of text snippets with a second text snippet of a second set of text snippets extracted from a collection of documents including multimodal data, wherein the source attribution indicates a section of a document within the collection of documents associated with the second text snippet extracted from the collection of documents;
causing the second machine learning model to determine a first multimodal data associated with the section to include in a second response based on a similarity between a set of context information associated with the multimodal data and the first text snippet;
generating a prompt including the first response and a first context information of the set of context information associated with the first multimodal data; and
providing, in response to the user query, the second response generated by the first machine learning model in response to the prompt being provided as an input to the first machine learning model.

2. The method of claim 1, wherein generating the prompt further comprises including a place holder associated with the first multimodal data in the prompt.

3. The method of claim 1, wherein the method further comprises causing the first machine learning model to generate the set of context information based on the multimodal data.

4. The method of claim 3, wherein the first context information of the set of context information includes a summary of a transcript associated with the first multimodal data.

5. The method of claim 3, wherein the first context information of the set of context information includes a caption generated based on the first multimodal data.

6. The method of claim 1, wherein the first machine learning model is fine-tuned based on the second set of text snippets from the collection of documents.

7. The method of claim 6, wherein the first machine learning model is a large language model and the second machine learning model is a sentence encoder.

8. A non-transitory computer-readable medium storing executable instructions embodied thereon, that, as a result of being executed by a processing device, cause the processing device to perform operations comprising:
extracting a first set of sentences from documentation including multimodal data;
obtaining, from an application, a query associated with the documentation;
causing a first machine learning model to generate a first response to the query;
causing a second machine learning model to determine a location within the documentation to retrieve a first multimodal data by matching a first text sentence the first set of sentences to a second sentence included in the first response;
obtaining the first multimodal data from the location within the documentation based on a similarity between context data associated with the first multimodal data and the second sentence;
providing, to the first machine learning model, a prompt generated based on the first response and the context data; and
providing, to the application, a second response generated by the first machine learning model based on the prompt.

9. The medium of claim 8, wherein the prompt further comprises the first multimodal data.

10. The medium of claim 8, wherein extracting the first set of sentences from the documentation including the multimodal data further comprises causing generation of a set of context data associated with the multimodal data.

11. The medium of claim 10, wherein the set of context data associated with the multimodal data is generated by the first machine learning model by at least providing to the first machine learning model metadata associated with the multimodal data and the multimodal data.

12. The medium of claim 8, wherein generating the prompt based on the first response, the first multimodal data, and the context data further comprises including a placeholder representing the first multimodal data in the prompt.

13. The medium of claim 12, wherein providing to the application the second response further comprises replacing the placeholder with the first multimodal data.

14. The medium of claim 8, wherein the first machine learning model is trained at least in part based on the documentation.

15. The medium of claim 8, wherein the similarity between the context data associated with the first multimodal data and the second sentence is determined by the second machine learning model.

16. A system comprising:
a memory component; and
a processing device coupled to the memory component, the processing device to perform operations comprising:
generating a first set of text snippets from a corpus of data including multimodal data;
causing a first machine learning model to generate a first response by providing a query as an input to the first machine learning model;
generating a second set of text snippets from the first response;
causing a second machine learning model to determine a first multimodal data that is relevant to a first text snippet of the second set of text snippets to include in a second response, the first multimodal data determined based on a similarity between the first text snippet and context information associated with the first multimodal data;
generating a prompt including the first response, a placeholder associated with the first multimodal data, and the context information; and
causing the first machine learning model to generate the second response based on the prompt.

17. The system of claim 16, wherein causing the second machine learning model to determine the first multimodal data further comprises causing the second machine learning model to determine a location within the corpus of data associated with the first multimodal data.

18. The system of claim 17, wherein determining the location further comprise causing the second machine learning model to determine a second text snippet of the first set of text snippets was used by the first machine learning model to generate the first text snippet of the second set of text snippets.

19. The system of claim 16, wherein the placeholder includes a copy of the multimodal data.

20. The system of claim 16, wherein generating the first set of text snippets from the corpus of data including the multimodal data further comprises generating a set of context information associated with the multimodal data, wherein the context information is a member of the set of context information.
